(19) United States
(12) Patent Application Publication
(10) Pub. No.: US 2026/0052001 A1
(43) Pub. Date: Feb. 19, 2026

(54) METHODS AND APPARATUSES FOR REPEATER

(71) Applicant: Lenovo (Beijing) Limited, Beijing (CN)

(72) Inventors: Hongmei Liu, Beijing (CN); Yuantao Zhang, Beijing (CN); Zhi Yan, Beijing (CN); Ruixiang Ma, Beijing (CN); Haiming Wang, Beijing (CN)

(73) Assignee: Lenovo (Beijing) Limited, Beijing (CN)

(21) Appl. No.: 19/102,883

(22) PCT Filed: Aug. 11, 2022
(86) PCT No.: PCT/CN2022/111721

§ 371 Date: Feb. 11, 2025

(51) Int. Cl. H04L 5/14; H04B 7/06; H04L 5/00

(52) U.S. Cl. CPC H04L 5/1469; H04B 7/06968; H04L 5/0048

(57) ABSTRACT

Embodiments of the present disclosure relate to methods and apparatuses for repeater. According to some embodiments of the present disclosure, a network node may include: a transceiver configured to receive configuration information for a set of reference signals (RSs); a processor coupled to the transceiver and configured to determine at least one of a power gain, a beam identity (ID), a transmission configuration indicator (TCI) state ID, or a quasi-colocation (QCL) type D property for each RS in the set of RSs; wherein the transceiver is further configured to transmit the set of RSs based on the determined at least one of the power gain, the beam ID, the TCI state ID, or the QCL type D property for each RS.

### TECHNICAL FIELD

The present disclosure generally relates to wireless communication technology, and more particularly to methods and apparatuses for repeater.

### BACKGROUND

Wireless communication systems are widely deployed to provide various telecommunication services, such as telephony, video, data, messaging, broadcasts, and so on. Wireless communication systems may employ multiple access technologies capable of supporting communication with multiple users by sharing available system resources (e.g., time, frequency, and power). Examples of wireless communication systems may include fourth generation (4G) systems, such as long term evolution (LTE) systems, LTE-advanced (LTE-A) systems, or LTE-A Pro systems, and fifth generation (5G) systems which may also be referred to as new radio (NR) systems.

To enhance the coverage of a BS, relay nodes, such as repeaters may be deployed in a wireless communication system, which can improve signal quality of a mobile device in certain conditions, e.g., a UE that locates in a coverage hole or far from the BS. An NC repeater (also referred to as a smart repeater) is an enhancement over conventional repeaters with the capability to receive and process side control information from the network. Side control information could allow an NC repeater to perform its amplify-and-forward operation in a more efficient manner. Potential benefits may include mitigation of unnecessary noise amplification, transmissions and receptions with better spatial directivity, and simplified network integration. However, operation details of the repeaters, e.g. power gain determination, beam determination, side control information determination, and other parameters, are expected to promote the throughput of the wireless communication system.

### SUMMARY

Some embodiments of the present disclosure provide a network node. The network node may include: a transceiver configured to receive configuration information for a set of reference signals (RSs); a processor coupled to the transceiver and configured to determine at least one of a power gain, a beam identity (ID), a transmission configuration indicator (TCI) state ID, or a quasi-colocation (QCL) type D property for each RS in the set of RSs; wherein the transceiver is further configured to transmit the set of RSs based on the determined at least one of the power gain, the beam ID or the TCI state ID for each RS.

In some embodiments of the present disclosure, the set of RSs is used for at least one of: a power gain measurement or a beam measurement.

In some embodiments of the present disclosure, the configuration information indicates at least one of the power gain, the beam ID, the TCI state ID, or the QCL type D property for each RS in the set of RSs.

In some embodiments of the present disclosure, the configuration information indicates a first number of beam IDs and a second number of power gains associated with the set of RSs or a first number of TCI state IDs and a second number of power gains associated with the set of RSs or a first number of QCL type D properties and a second number of power gains associated with the set of RSs.

In some embodiments of the present disclosure, the configuration information indicating a mapping order between the set of RSs and the first number of beam IDs and the second number of power gains or between the set of RSs and the first number of TCI state IDs and the second number of power gains or between the set of RSs and the first number of QCL type D properties and the second number of power gains; or a mapping order between the set of RSs and the first number of beam IDs and the second number of power gains or between the set of RSs and the first number of TCI state IDs and the second number of power gains or between the set of RSs and the first number of QCL type D properties and the second number of power gains is pre-defined.

In some embodiments of the present disclosure, an RS in the set of RSs is one of: a sounding reference signal (SRS), a synchronization signal block (SSB), or a channel state information reference signal (CSI-RS).

In some embodiments of the present disclosure, the transceiver is further configured to receive indication information including at least one indication, wherein each indication indicates at least one of: a power gain, a beam ID, a TCI state ID, or a QCL type D property.

In some embodiments of the present disclosure, each indication indicates an index of an RS, wherein the index of the RS is associated with at least one of: a power gain, a beam ID, a TCI state ID, or a QCL type D property.

In some embodiments of the present disclosure, the indication information is periodic indication information, and the transceiver is further configured to receive at least one of a periodicity, an offset, a duration and time instance index(es) for the indication information.

In some embodiments of the present disclosure, the indication information is aperiodic indication information, and the transceiver is further configured to receive at least one of an application time or a duration for the indication information.

In some embodiments of the present disclosure, the transceiver is further configured to receive a mapping relationship between at least one power gain indicated by the indication information and at least one beam ID or at least one TCI state ID or at least one QCL type D property, and the processor is further configured to determine a power gain for a time instance based on a beam ID or a TCI state ID or a QCL type D property corresponding to the power gain.

In some embodiments of the present disclosure, the at least one indication is separately for DL and UL or jointly for DL and UL.

In some embodiments of the present disclosure, the indication information is received in group common downlink control information (DCI) or in a medium access control (MAC) control element (CE).

In some embodiments of the present disclosure, the processor is further configured to determine a default power gain for a time instance when no power gain is indicated for the time instance.

Some embodiments of the present disclosure provide a base station (BS). The BS may include: a transceiver configured to: transmit configuration information for a set of RSs; transmit the set of RSs or receive the set of reference signals.

In some embodiments of the present disclosure, the set of RSs is used for at least one of: a power gain measurement or a beam measurement.

In some embodiments of the present disclosure, the configuration information indicates at least one of a power gain, a beam ID, a TCI state ID, or a QCL type D property for each RS in the set of RSs.

In some embodiments of the present disclosure, the configuration information indicates a first number of beam IDs and a second number of power gains associated with the set of RSs or a first number of TCI state IDs and a second number of power gains associated with the set of RSs or a first number of QCL type D properties and a second number of power gains associated with the set of RSs.

In some embodiments of the present disclosure, the configuration information indicating a mapping order between the set of RSs and the first number of beam IDs and the second number of power gains or between the set of RSs and the first number of TCI state IDs and the second number of power gains or between the set of RSs and the first number of QCL type D properties and the second number of power gains.

In some embodiments of the present disclosure, an RS in the set of RSs is one of: a SRS, an SSB, or a CSI-RS.

In some embodiments of the present disclosure, the transceiver is further configured to transmit indication information including at least one indication, wherein each indication indicates at least one of: a power gain, a beam ID, a TCI state ID, or a QCL type D property.

In some embodiments of the present disclosure, each indication indicates an index of an RS, wherein the index of the RS is associated with at least one of: a power gain, a beam ID, a TCI state ID, or a QCL type D property.

In some embodiments of the present disclosure, the indication information is periodic indication information, and the transceiver is further configured to transmit at least one of periodicity, offset, duration and time instance index for the indication information.

In some embodiments of the present disclosure, the indication information is aperiodic indication information, and the transceiver is further configured to transmit at least one of an application time or a duration for the indication information.

In some embodiments of the present disclosure, the transceiver is further configured to transmit a mapping relationship between at least one power gain indicated by the indication information and at least one beam ID or at least one TCI state ID or at least one QCL type D property, and the processor is further configured to determine a power gain for a time instance based on a beam ID or a TCI state ID or a QCL type D property corresponding to the power gain.

In some embodiments of the present disclosure, the at least one indication is separately for DL and UL or jointly for DL and UL.

In some embodiments of the present disclosure, the indication information is transmitted in group common DCI or in a MAC CE.

In some embodiments of the present disclosure, the processor is further configured to determine a default power gain for a time instance when no power gain is indicated for the time instance.

Some embodiments of the present disclosure provide a network node. The network node may include: a transceiver configured to receive control information which includes at least one of: an on-off configuration which indicates an on-off state for each time instance of at least one time instance; a TDD configuration which indicates DL, UL or flexible for each time instance of at least one time instance; one or more beam related indications, wherein each beam related indication indicates a beam ID for a corresponding time instance of at least one time instance; one or more TCI state related indications, wherein each TCI state related indication indicates a TCI state ID for a corresponding time instance of at least one time instance; one or more quasi-colocation (QCL) type D property related indications, wherein each QCL type D property related indication indicates a QCL type D property for a corresponding time instance of at least one time instance; one or more power gain indications, wherein each power gain indication indicates a power gain for a corresponding time instance of at least one time instance; and a processor coupled to the transceiver and configured to determine at least one of a TDD configuration, an on-off state, a beam ID, a TCI state ID, a QCL type D property, or a power gain for a time instance based on the control information.

In some embodiments of the present disclosure, in the case that the on-off configuration is included in the control information, the processor is configured to determine the time instance to be an off state in response to at least one of the TDD configuration indicates flexible for the time instance or the on-off configuration indicates an off state for the time instance; or wherein in the case that the on-off configuration is not included in the control information, the processor is configured to determine the time instance to be an off state in response to at least one of the TDD configuration indicates flexible for the time instance, a beam related indication indicates a pre-defined beam ID for the time instance, a TCI state related indication indicates a pre-defined TCI state ID, a QCL type D property related indication indicates a pre-defined QCL type D property, or a power gain indication indicates a pre-defined power gain for the time instance.

In some embodiments of the present disclosure, a beam related indication or a TCI state related indication or a QCL type D property related indication is associated with a priority.

In some embodiments of the present disclosure, the priority is explicitly configured in the control information.

In some embodiments of the present disclosure, the priority is determined based on at least one of: a scrambling ID of a physical downlink channel, radio network temporary identity (RNTI) of a physical downlink channel, or whether the beam related indication or the TCI state related indication or the QCL type D property related indication is periodic or aperiodic.

In some embodiments of the present disclosure, in the case that the control information includes more than one beam related indication or more than one TCI state related indication or more than one QCL type D property related indication for the time instance, the processor is further configured to determine a beam related indication or a TCI state related indication a QCL type D property related indication with a highest priority from the more than one beam related indication or more than one TCI state related indication or more than one QCL type D property related indication for the time instance.

In some embodiments of the present disclosure, a power gain indication is associated with a priority.

In some embodiments of the present disclosure, the priority is explicitly configured in the control information.

In some embodiments of the present disclosure, the priority associated with the power gain indication is determined based on at least one of: a scrambling ID of a physical downlink channel, an RNTI of a physical downlink channel, or whether the power gain indication is periodic or aperiodic.

In some embodiments of the present disclosure, in the case that the control information includes more than one power gain indication for the time instance, the processor is further configured to determine a power gain indication with a highest priority from the more than one power gain indication for the time instance.

Some embodiments of the present disclosure provide a base station. The BS may include: a transceiver configured to transmit control information which includes at least one of: an on-off configuration which indicates an on-off state for each time instance of at least one time instance; a time division duplexing (TDD) configuration which indicates DL, UL or flexible for each time instance of at least one time instance; one or more beam related indications, wherein each beam related indication indicates a beam ID for a corresponding time instance of at least one time instance; one or more TCI state related indications, wherein each TCI state related indication indicates a TCI state ID for a corresponding time instance of at least one time instance; one or more quasi-colocation (QCL) type D property related indications, wherein each QCL type D property related indication indicates a QCL type D property for a corresponding time instance of at least one time instance; one or more power gain indications, wherein each power gain indication indicates a power gain for a corresponding time instance of at least one time instance; and a processor coupled to the transceiver and configured to determine at least one of a TDD configuration, an on-off state, a beam ID, a TCI state ID, a QCL type D property, or a power gain for a time instance based on the control information.

In some embodiments of the present disclosure, in the case that the on-off configuration is included in the control information, the processor is further configured to determine the time instance to be an off state in response to the TDD configuration indicates flexible for the time instance or the on-off configuration indicates an off state for the time instance; or wherein in the case that the on-off configuration is not included in the control information, the processor is further configured to determine the time instance to be an off state in response to at least one of the TDD configuration indicates flexible for the time instance, a beam related indication indicates a pre-defined beam ID for the time instance, a TCI state related indication indicates a pre-defined TCI state ID, a QCL type D property related indication indicates a pre-defined QCL type D property, or a power gain indication indicates a pre-defined power gain for the time instance.

In some embodiments of the present disclosure, a beam related indication or a TCI state related indication or a pre-defined QCL type D property is associated with a priority.

In some embodiments of the present disclosure, the priority is explicitly configured in the control information.

In some embodiments of the present disclosure, the priority is determined based on at least one of: a scrambling ID of a physical downlink channel, an RNTI of a physical downlink channel, or whether the beam related indication or the TCI state related indication or the QCL type D property related indication is periodic or aperiodic.

In some embodiments of the present disclosure, in the case that the control information includes more than one beam related indication or more than one TCI state related indication or more than one QCL type D property related indication for the time instance, the processor is further configured to determine a beam related indication or a TCI state related indication or a QCL type D property related indication with a highest priority from the more than one beam related indication or more than one TCI state related indication or more than one QCL type D property related indication for the time instance for the time instance.

In some embodiments of the present disclosure, a power gain indication is associated with a priority.

In some embodiments of the present disclosure, the priority is explicitly configured in the control information.

In some embodiments of the present disclosure, the priority associated with the power gain indication is determined based on at least one of: a scrambling ID of a physical downlink channel, an RNTI of a physical downlink channel, or whether the power gain indication is periodic or aperiodic.

In some embodiments of the present disclosure, in the case that the control information includes more than one power gain indication for the time instance, the processor is further configured to determine a power gain indication with a highest priority from the more than one power gain indication for the time instance.

Some embodiments of the present disclosure provide a method performed by a network node. The method may include: receiving configuration information for a set of RSs; determining at least one of a power gain, a beam ID, a TCI state ID, or a QCL type D property for each RS in the set of RSs; and transmitting the set of RSs based on the determined at least one of the power gain, the beam ID, the TCI state ID, or the QCL type D property for each RS.

Some embodiments of the present disclosure provide a method performed by a BS. The method may include: transmitting configuration information for a set of RSs; and transmitting the set of RSs or receive the set of reference signals.

Some embodiments of the present disclosure provide a method performed by a network node. The method may include: receiving control information which includes at least one of: an on-off configuration which indicates an on-off state for each time instance time instance of at least one time instance; a TDD configuration which indicates DL, UL or flexible for each time instance of at least one time instance; one or more beam related indications, wherein each beam related indication indicates a beam ID for a corresponding time instance of at least one time instance; one or more TCI state related indications, wherein TCI state related indication indicates a TCI state ID for a corresponding time instance of at least one time instance; one or more quasi-colocation (QCL) type D property related indications, wherein each QCL type D property related indication indicates a QCL type D property for a corresponding time instance of at least one time instance; one or more power gain indications, wherein each power gain indication indicates a power gain for a corresponding time instance of at least one time instance; and determining at least one of a TDD configuration, an on-off state, a beam ID, a TCI state ID, a QCL type D property, or a power gain for a time instance based on the control information.

Some embodiments of the present disclosure provide a method performed by a BS. The method may include: transmitting control information which includes at least one of: an on-off configuration which indicates an on-off state for each time instance time instance of at least one time instance; a TDD configuration which indicates DL, UL or flexible for each time instance of at least one time instance; one or more beam related indications, wherein each beam related indication indicates a beam ID for a corresponding time instance of at least one time instance; one or more TCI state related indications, wherein TCI state related indication indicates a TCI state ID for a corresponding time instance of at least one time instance; one or more quasi-colocation (QCL) type D property related indications, wherein each QCL type D property related indication indicates a QCL type D property for a corresponding time instance of at least one time instance; one or more power gain indications, wherein each power gain indication indicates a power gain for a corresponding time instance of at least one time instance; and determining at least one of a TDD configuration, an on-off state, a beam ID, a TCI state ID, a QCL type D property, or a power gain for a time instance based on the control information.

Some embodiments of the present disclosure provide an apparatus. According to some embodiments of the present disclosure, the apparatus may include: at least one non-transitory computer-readable medium having stored thereon computer-executable instructions; at least one receiving circuitry; at least one transmitting circuitry; and at least one processor coupled to the at least one non-transitory computer-readable medium, the at least one receiving circuitry and the at least one transmitting circuitry, wherein the at least one non-transitory computer-readable medium and the computer executable instructions may be configured to, with the at least one processor, cause the apparatus to perform a method according to some embodiments of the present disclosure.

### BRIEF DESCRIPTION OF THE DRAWINGS

In order to describe the manner in which the advantages and features of the disclosure can be obtained, a description of the disclosure is rendered by reference to specific embodiments thereof, which are illustrated in the appended drawings. These drawings depict only exemplary embodiments of the disclosure and are not therefore to be considered limiting of its scope.

FIG. 1 is a schematic diagram illustrating an exemplary wireless communication system according to some embodiments of the present application.

FIG. 2 illustrates an exemplary wireless communication system with repeaters according to some embodiments of the present application;

FIG. 3 is a flow chart illustrating an exemplary method for determining at least one of a power gain or a beam for a repeater according to some embodiments of the present disclosure;

FIG. 4 is an exemplary method for indicating power gain in Embodiment 1 of the present disclosure;

FIG. 5 is an exemplary method for determining a power gain and a beam ID for each RS in Embodiment 2 of the present disclosure;

FIG. 6 is a flow chart illustrating an exemplary method for determining at least one of a power gain or a beam for a repeater according to some other embodiments of the present disclosure;

FIG. 7 is a flow chart illustrating an exemplary method for indicating at least one of a power gain and a beam for a repeater according to some embodiments of the present disclosure;

FIG. 8 is an exemplary method for determining power gains for a duration according to some embodiments of the present disclosure;

FIG. 9 is an exemplary method for determining power gains for a duration according to some other embodiments of the present disclosure;

FIG. 10 is an exemplary method for determining power gains for a duration according to some other embodiments of the present disclosure.

FIG. 11 is a flow chart illustrating an exemplary method for determining control information according to some embodiments of the present disclosure;

FIG. 12 is an exemplary method for determining control information according to some embodiments of the present disclosure;

FIG. 13 is an exemplary method for determining control information according to some other embodiments of the present disclosure; and

FIG. 14 illustrates a simplified block diagram of an exemplary apparatus for repeater according to some embodiments of the present disclosure.

### DETAILED DESCRIPTION

The detailed description of the appended drawings is intended as a description of the preferred embodiments of the present disclosure and is not intended to represent the only form in which the present disclosure may be practiced. It should be understood that the same or equivalent functions may be accomplished by different embodiments that are intended to be encompassed within the spirit and scope of the present disclosure.

Reference will now be made in detail to some embodiments of the present disclosure, examples of which are illustrated in the accompanying drawings. To facilitate understanding, embodiments are provided under a specific network architecture(s) and new service scenarios, such as the 3rd generation partnership project (3GPP) 5G (NR), 3GPP long-term evolution (LTE), and so on. It is contemplated that along with the developments of network architectures and new service scenarios, all embodiments in the present disclosure are also applicable to similar technical problems; and moreover, the terminologies recited in the present disclosure may change, which should not affect the principles of the present disclosure.

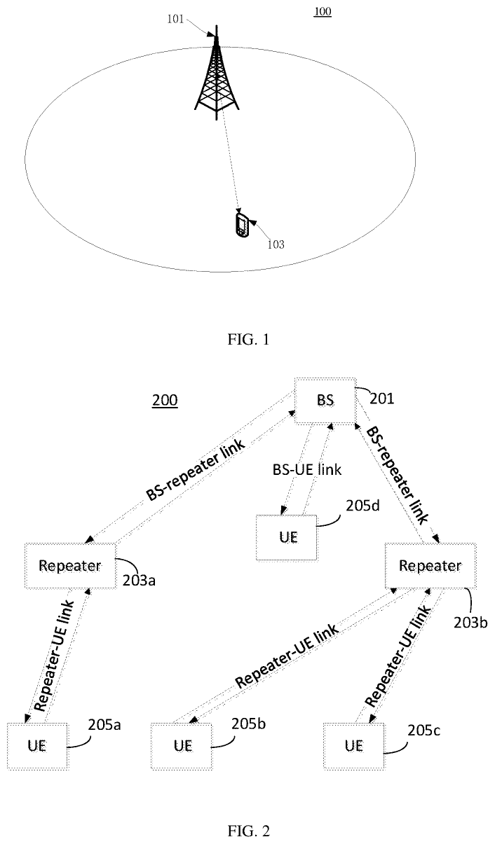

FIG. 1 illustrates a schematic diagram of an exemplary wireless communication system 100 according to some embodiments of the present application.

As shown in FIG. 1, the wireless communication system 100 includes a UE 103 and a BS 101. Although merely one BS is illustrated in FIG. 1 for simplicity, it is contemplated that the wireless communication system 100 may include more BSs in some other embodiments of the present application. Similarly, although merely one UE is illustrated in FIG. 1 for simplicity, it is contemplated that the wireless communication system 100 may include more UEs in some other embodiments of the present application.

The wireless communication system 100 is compatible with any type of network that is capable of sending and receiving wireless communication signals. For example, the wireless communication system 100 is compatible with a wireless communication network, a cellular telephone network, a time division multiple access (TDMA)-based network, a code division multiple access (CDMA)-based network, an orthogonal frequency division multiple access (OFDMA)-based network, an LTE network, a 3GPP-based network, a 3GPP 5G network, a satellite communications network, a high altitude platform network, and/or other communications networks.

The BS 101 may also be referred to as an access point, an access terminal, a base, a macro cell, a node-B, an enhanced node B (eNB), a gNB, a home node-B, a relay node, or a device, or described using other terminology used in the art. The BS 101 is generally part of a radio access network that may include a controller communicably coupled to the BS 101.

The UE 103 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to an embodiment of the present application, the UE 103 may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments of the present application, the UE 103 may include wearable devices, such as smart watches, fitness bands, optical head-mounted displays, or the like. Moreover, the UE 103 may be referred to as a subscriber unit, a mobile, a mobile station, a user, a terminal, a mobile terminal, a wireless terminal, a fixed terminal, a subscriber station, a user terminal, or a device, or described using other terminology used in the art.

To enhance the coverage area of a BS, relay nodes, such as repeaters may be deployed in a wireless communication system, which can improve the throughput of a mobile device in low signal quality, e.g., a UE that locates in a coverage hole or far from the BS.

FIG. 2 illustrates an exemplary wireless communication system with repeaters according to some embodiments of the present application.

Referring to FIG. 2, in the exemplary wireless communication system 200, there are multiple nodes, e.g., a BS 201, a first repeater 203a, a second repeater 203b, a first UE 205a, a second UE 205b, a third UE 205c and a fourth UE 205d. The first repeater 203a is connected with the BS 201 and the first UE 205a, the second repeater 203b is connected with the BS 201 and the second UE 205b and the third UE 205c. A link between the BS 201 and a repeater, e.g., the first repeater 203a or the second repeater 203b can be referred to a BS-repeater link (or a backhaul link), a link between a repeater, e.g., the first repeater 203a and a UE, e.g., the first UE 205a can be referred to a repeater-UE link (or an access link); and a link between the BS 201 and a UE, e.g., the fourth UE 205d can be referred to as a BS-UE link.

Persons skilled in the art should well know that each BS, e.g., the BS 201 can connect with one or more repeaters, e.g., the first repeater 203a and second repeater 203b, and one or more UEs, e.g., the first UE 205a, the second UE 205b, the third UE 205c and the fourth UE 205d; and each repeater, e.g., the first repeater 203a and the second repeater 203b can connect with one or more BSs and one or more UEs. Thus, the exemplary nodes in the wireless communication system 200 with a limited number should not be deemed as the limitation to the present application.

According to RP-213592, smart repeaters (also referred to as NC repeaters), which are transparent to UEs will be studied and identified. An NC repeater can maintain the BS-repeater link and repeater-UE link simultaneously, and is an enhancement over conventional repeaters with the capability to receive and process side control information from the network. Side control information could allow an NC repeater to perform its amplify-and-forward operation in a more efficient manner.

In some cases, a power gain of an NC repeater may be adjusted for interference management. Then, how to determine and indicate the power gain for an NC repeater needs to be addressed. In some examples, the power gain may be for DL RS (or channel) forwarding or UL channel (or RS) forwarding. In some other examples, the power gain is at the repeater, and it may be for access link or for backhaul link. In some examples, the power gain may be the amplifying gain at the repeater for DL (or UL) channel (or RS). In some examples, the power gain may be a power value or at the repeater for DL (or UL) channel (or RS).

In some cases, an NC repeater may be configured with multiples beams for DL forwarding or UL forwarding. Then, how to determine and indicate a beam for DL forwarding or UL forwarding needs to be addressed.

In some cases, there may be multiple kinds of side control information configured for an NC repeater, for example, the side control information may include at least one of: a TDD configuration, an on-off configuration, one or multiple beam related indications (or multiple TCI related indications), or one or multiple power gain related indications. Then, how to determine the side control information applied to a time instance needs to be addressed.

Given the above, embodiments of the present disclosure provide enhanced solutions for a repeater (e.g., NC repeater). For example, embodiments of the present disclosure provide solutions for determining (or indicating) at least one of a power gain or a beam for a repeater as well as solutions for determining side control information for a repeater. The enhanced solutions in the embodiments of the present disclosure can at least solve the above technical problems. More details on embodiments of the present disclosure will be described in the following text in combination with the appended drawings.

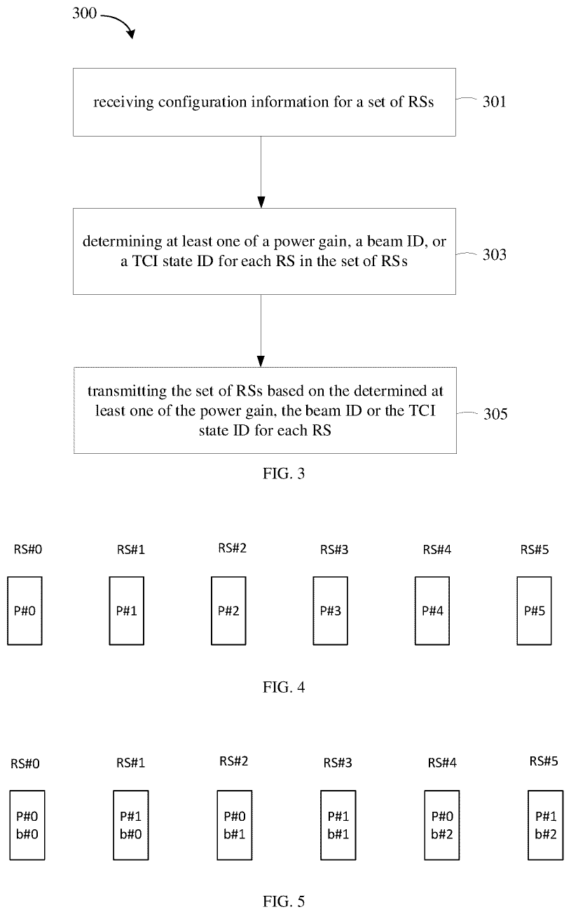

FIG. 3 is a flow chart illustrating an exemplary method 300 for determining at least one of a power gain or a beam for a repeater according to some embodiments of the present disclosure. The method in FIG. 3 may be implemented by a network node, e.g., a repeater (e.g., repeater 203a or 203b in FIG. 2) or other network node with the similar functions. In some embodiments of FIG. 3, the repeater may be an NC repeater or a smart repeater. In some other embodiments, the repeater may be any other repeater.

In the exemplary method shown in FIG. 3, in step 301, a network node may receive, from a BS (e.g., BS 101 in FIG. 1 or BS 201 in FIG. 2), configuration information for a set of RSs. In step 303, the network node may determine at least one of a power gain, a beam ID, or a TCI state ID for each RS in the set of RSs. In step 305, the network node may transmit the set of RSs based on the determined at least one of the power gain, the beam ID or the TCI state ID for each RS. The specific operations in each step may be illustrated in the following embodiments.

### Embodiment I

In embodiment I, the set of RSs may be used for a power gain measurement for the network node.

According to some embodiments of the present application, the set of RSs may be a set of DL RSs. For example, a DL RS may be one of an SSB and a CSI-RS. In such embodiments, the configuration information for the set of DL RSs in step 301 may indicate a set of DL resources (e.g., time and frequency resources) for the set of DL RSs, wherein each DL resource in the set of DL resources is used for transmitting or receiving a corresponding DL RS of the set of DL RSs. Each DL RS (or each DL resource) may be associated with a power gain for DL forwarding. Each DL RS may be associated with a beam ID for access link. Different DL RSs (or DL resources) may be associated with the same beam ID or different beam IDs for access link.

In embodiment I, only power gains may be swept for the set of DL RSs. Beam IDs may be determined by measuring other DL RSs.

In embodiment I, the network node may determine a power gain for each DL RS in the set of DL RSs in step 303. The power gain may be determined based on the methods in the following embodiments.

In some embodiments, the power gain for each DL RS is explicitly configured from the BS to the network node. In such embodiments, the configuration information may indicate a power gain for each DL RS in the set of DL RSs. The network node may determine the power gain for each DL RS in the set of DL RSs based on the indication.

In such embodiments, the network node may receive the set of DL RSs from the BS. Then, in step 305, the network node may transmit each DL RS in the set of DL RSs to a UE (e.g., UE 103 in FIG. 1 or UE 205a, 205b, or UE 205c in FIG. 2) based on the determined power gain for each DL RS in the set of DL RSs. For the UE, the set of DL RSs may have the same purposes as legacy to keep transparent, e.g., the set of DL RSs may be used for at least one of: reference signal receiving power (RSRP) measurement, reference signal receiving quality (RSRQ) measurement, or received signal strength indicator (RSSI) measurement.

In some cases, based on the measurements and reporting on the set of DL RSs from the UE, the BS may determine at least one power gain which is suitable for the network node. Then, the BS may transmit an indication indicating the at least one power gain to the network node. Consequently, the network node may receive the indication indicating the at least one power gain from the BS.

In some other embodiments, the power gain for each DL RS is determined by the network node itself. In such embodiments, the network node may receive the set of DL RSs from the BS. Then, in step 305, the network node may transmit each DL RS in the set of DL RSs to a UE (e.g., UE 103 in FIG. 1 or UE 205a, 205b, or UE 205c in FIG. 2) based on the determined power gain for each DL RS in the set of DL RSs.

In some cases, based on the measurements and reporting on the set of DL RSs from the UE, the BS may determine index(es) of at least one DL RS (or at least one DL resource for the at least one DL RS) which is suitable for the network node. An index of a DL RS is associated with a determined or selected power gain at the network node. The association between an index of a DL RS and a power gain may be determined by the network node's implementation. Then, the BS may transmit an indication to the network node, the indication may include an index of each DL RS of the at least one DL RS (or an index of each DL resource of the at least one DL resource). Consequently, the network node may receive the indication. Based the index of each DL RS (or the index of each DL resource), the network node may determine a corresponding power gain associated with the index for each DL RS (or the index of each DL resource).

According to some embodiments of the present application, the set of RSs may be a set of UL RSs. For example, a UL RS may be an SRS. In such embodiments, the configuration information for the set of DL RSs in step 301 may indicate a set of UL resources (e.g., time and frequency resources) for the set of UL RSs, wherein each UL resource in the set of UL resources is used for transmitting a corresponding UL RS of the set of UL RSs. Each UL RS (or each UL resource) may be associated with a power gain for UL forwarding and associated with a beam ID for UL forwarding. The beam ID may be for access link or for backhaul link. Different UL RSs (or UL resources) may be associated with the same beam ID or different beam IDs for UL forwarding.

In embodiment I, only power gains may be swept for the set of UL RSs. Beam IDs may be determined by measuring other UL RSs.

In embodiment I, the network node may determine a power gain for each UL RS in the set of UL RSs in step 303. The power gain may be determined based on the methods in the following embodiments.

In some embodiments, the power gain for each UL RS is explicitly configured from the BS to the network node. In such embodiments, the configuration information may indicate a power gain for each UL RS in the set of UL RSs. The network node may determine the power gain for each UL RS in the set of UL RSs based on the indication.

In such embodiments, the network node may receive the set of UL RSs from the UE. For the UE, the set of UL RSs may have the same purposes as legacy to keep transparent. Then, in step 305, the network node may transmit each UL RS in the set of UL RSs to the BS based on the determined power gain for each UL RS in the set of UL RSs.

In some cases, based on the measurements on the set of UL RSs, the BS may determine at least one power gain which is suitable for the network node to perform UL forwarding. Then, the BS may transmit an indication indicating the at least one power gain to the network node. Consequently, the network node may receive the indication indicating the at least one power gain from the BS.

In some other embodiments, the power gain for each UL RS is determined by the network node itself. In such embodiments, the network node may receive the set of UL RSs from the UE. There will be an association between an index of a UL RS and a determined power gain. Then, in step 305, the network node may transmit each UL RS in the set of UL RSs to the BS based on the determined power gain for each UL RS in the set of UL RSs.

In some cases, based on the measurements on the set of UL RSs, the BS may determine index(es) of at least one UL RS (or at least one UL resource for the at least one UL RS) which is suitable for the network node. An index of a UL RS is associated with a determined or selected power gain at the network node. The association between an index of a UL RS and a power gain may be determined by the network node's implementation. Then, the BS may transmit an indication to the network node, the indication may include an index of each UL RS of the at least one UL RS (or an index of each UL resource of the at least one UL resource). Consequently, the network node may receive the indication. Based the index of each UL RS (or the index of each UL resource), the network node may determine a corresponding power gain associated with the index for each UL RS (or the index of each UL resource) to perform UL forwarding (e.g., transmitting UL transmission to the BS).

FIG. 4 is an exemplary method for indicating power gain in Embodiment 1 of the present disclosure. Referring to FIG. 4, it is assumed that the set of RSs includes six RSs, e.g., denoted as RS #0, RS #1, RS #2, RS #3, RS #4, and RS #5. The BS may transmit an indication to the network node. The indication may indicate: a power gain (denoted as P #0) for RS #0, a power gain (denoted as P #1) for RS #1, a power gain (denoted as P #2) for RS #2, a power gain (denoted as P #3) for RS #3, a power gain (denoted as P #4) for RS #4, and a power gain (denoted as P #5) for RS #5.

### Embodiment II

In embodiment II, the set of RSs may be used for a power gain measurement and a beam measurement for the network node.

According to some embodiments of the present application, the set of RSs may be a set of DL RSs. All the definitions regarding the set of DL RSs in Embodiment I may apply here.

In embodiment II, each DL RS (or each DL resource) may be associated with a power gain and a beam ID (or a TCI state ID or a QCL type D property) for DL forwarding. Accordingly, both the beam IDs (or the TCI state IDs or the QCL type D properties) and power gains may be swept for the set of DL RSs.

In embodiment II, the network node may determine a power gain and a beam ID (or a TCI state ID or a QCL type D property) for each DL RS in the set of DL RSs in step 303. The power gain and a beam ID (or a TCI state ID or a QCL type D property) may be determined based on the methods in the following embodiments.

In some embodiments, the power gain and the beam ID (or the TCI state ID or the QCL type D property) for each DL RS are explicitly configured from the BS to the network node. In such embodiments, the configuration information may indicate a power gain and a beam ID (or a TCI state ID or a QCL type D property) for each DL RS in the set of DL RSs. The network node may determine the power gain and the beam ID (or the TCI state ID or the QCL type D property) for each DL RS in the set of DL RSs based on the indication.

In such embodiments, the network node may receive the set of DL RSs from the BS. Then, in step 305, the network node may transmit each DL RS in the set of DL RSs to a UE (e.g., UE 103 in FIG. 1 or UE 205a, 205b, or UE 205c in FIG. 2) based on the determined power gain and the beam ID (or the TCI state ID or the QCL type D property) for each DL RS in the set of DL RSs. For the UE, the set of DL RSs may have the same purposes as legacy to keep transparent, e.g., the set of DL RSs may be used for at least one of: RSRP measurement, RSRQ measurement, or RSSI measurement.

In some cases, based on the measurements and reporting on the set of DL RSs from the UE, the BS may determine at least one set of power gain and beam ID (or TCI state ID or QCL type D property) which is suitable for the network node. Then, the BS may transmit an indication indicating the at least one set of power gain and beam ID (or TCI state ID or QCL type D property) to the network node. Consequently, the network node may receive the indication indicating the at least one set of power gain and beam ID (or TCI state ID or QCL type D property) from the BS.

In some other embodiments, the power gain and the beam ID (or the TCI state ID or QCL type D property) for each DL RS is determined by the network node.

In an embodiment, the network node itself may determine a power gain and a beam ID (or a TCI state ID or QCL type D property) for each DL RS.

In another embodiment, the configuration information in step 301 may further indicates a first number of beam IDs (or TCI state IDs or QCL type D properties) and a second number of power gains associated with the set of DL RSs. In some cases, the configuration information also indicates a mapping order between the set of DL RSs and the first number of beam IDs (or TCI state IDs or QCL type D properties) and the second number of power gains. In some other cases, a mapping order between the set of DL RSs and the first number of beam IDs (or TCI state IDs or QCL type D properties) and the second number of power gains may be pre-defined. Based on the mapping order, the UE may determine which power gain and beam ID (or TCI state ID or QCL type D property) is associated with each DL RS. For example, the mapping order may indicate to sweep beam firstly and power gain secondly or sweep power gain firstly and beam secondly. An example for determining a power gain and a beam ID for each RS may refer to FIG. 5. In FIG. 5, there are 3 beams and 2 power gains, and the mapping order is power gain firstly, and beam index secondly. Consequently, RS #0 is associated with beam #0 and power gain #0, RS #2 is associated with beam #1 and power gain #0, RS #3 is associated with beam #1 and power gain #1, etc.

In such embodiments, the network node may receive the set of DL RSs from the BS. Then, in step 305, the network node may transmit each DL RS in the set of DL RSs to a UE (e.g., UE 103 in FIG. 1 or UE 205a, 205b, or UE 205c in FIG. 2) based on the determined power gain and beam ID (or TCI state ID or QCL type D property) for each DL RS in the set of DL RSs.

In some cases, based on the measurements and reporting on the set of DL RSs from the UE, the BS may determine index(es) of at least one DL RS (or at least one DL resource for the at least one DL RS) which is suitable for the network node. An index of a DL RS is associated with a determined or selected power gain and a determined or selected beam ID (or TCI state ID or QCL type D property) at the network node. The association between an index of a DL RS and a power gain and a beam ID (or TCI state ID or QCL type D property) may be determined by the network node's implementation. Then, the BS may transmit an indication to the network node, the indication may include an index of each DL RS of the at least one DL RS (or an index of each DL resource of the at least one DL resource). Consequently, the network node may receive the indication. Based the index of each DL RS (or the index of each DL resource), the network node may determine a corresponding power gain and a corresponding beam ID (or TCI state ID or QCL type D property) associated with the index for each DL RS (or the index of each DL resource).

According to some embodiments of the present application, the set of RSs may be a set of UL RSs. All the definitions regarding the set of UL RSs in Embodiment I may apply here.

In embodiment II, each UL RS (or each UL resource) may be associated with a power gain and a beam ID (or a TCI state ID or a QCL type D property) for UL forwarding. Accordingly, both the beam IDs (or TCI state IDs or QCL type D properties) and power gains may be swept for the set of UL RSs.

In embodiment II, the network node may determine a power gain and a beam ID (or a TCI state ID or a QCL type D property) for each UL RS in the set of UL RSs in step 303. The power gain a beam ID (or a TCI state ID or a QCL type D property) may be determined based on the methods in the following embodiments.

In some embodiments, the power gain and the beam ID (or the TCI state ID or the QCL type D property) for each UL RS are explicitly configured from the BS to the network node. In such embodiments, the configuration information may indicate a power gain and a beam ID (or a TCI state ID or a QCL type D property) for each UL RS in the set of UL RSs. The network node may determine the power gain and the beam ID (or the TCI state ID or the QCL type D property) for each UL RS in the set of UL RSs based on the indication.

In such embodiments, the network node may receive the set of UL RSs from the UE. Then, in step 305, the network node may transmit each UL RS in the set of UL RSs to the BS based on the determined power gain and the beam ID (or the TCI state ID or the QCL type D property) for each UL RS in the set of UL RSs. For the UE, the set of UL RSs may have the same purposes as legacy to keep transparent.

In some cases, based on the measurements on the set of UL RSs, the BS may determine at least one set of power gain and beam ID (or TCI state ID or QCL type D property) which is suitable for the network node. Then, the BS may transmit an indication indicating the at least one set of power gain and beam ID (or TCI state ID or QCL type D property) to the network node. Consequently, the network node may receive the indication indicating the at least one set of power gain and beam ID (or TCI state ID or QCL type D property) from the BS.

In some other embodiments, the power gain and the beam ID (or the TCI state ID or the QCL type D property) for each UL RS is determined by the network node.

In an embodiment, the network node itself may determine a power gain and a beam ID (or a TCI state ID or a QCL type D property) for each UL RS. The network may maintain an association between a power gain, a beam ID (or a TCI state ID or a QCL type D property) and an index of a UL RS for following operations.

In another embodiment, the configuration information in step 301 may further indicates a first number of beam IDs (or TCI state IDs or QCL type D properties) and a second number of power gains associated with the set of UL RSs. In some cases, the configuration information also indicates a mapping order between the set of UL RSs and the first number of beam IDs (or TCI state IDs or QCL type D properties) and the second number of power gains. In some other cases, a mapping order between the set of UL RSs and the first number of beam IDs (or TCI state IDs or QCL type D properties) and the second number of power gains may be pre-defined. Based on the mapping order, the UE may determine which power gain and beam ID (or TCI state ID or QCL type D property) is associated with each UL RS. For example, the mapping order may indicate to sweep beam firstly and power gain secondly or sweep power gain firstly and beam secondly. An example for determining a power gain and a beam ID for each RS may refer to FIG. 5.

In such embodiments, the network node may receive the set of UL RSs from the UE. Then, in step 305, the network node may transmit each UL RS in the set of UL RSs to the BS based on the determined power gain and beam ID (or TCI state ID or QCL type D property) for each UL RS in the set of UL RSs.

In some cases, based on the measurements on the set of UL RSs, the BS may determine index(es) of at least one UL RS (or at least one UL resource for the at least one UL RS) which is suitable for the network node. An index of a UL RS is associated with a determined or selected power gain and a determined or selected beam ID (or TCI state ID or QCL type D property) at the network node. The association between an index of a UL RS and a power gain and a beam ID (or TCI state ID or QCL type D property) may be determined by the network node's implementation. Then, the BS may transmit an indication to the network node, the indication may include an index of each UL RS of the at least one UL RS (or an index of each UL resource of the at least one UL resource). Consequently, the network node may receive the indication. Based the index of each UL RS (or the index of each UL resource), the network node may determine a corresponding power gain and beam ID (or TCI state ID or QCL type D property) associated with the index for each UL RS (or the index of each UL resource).

FIG. 5 is an exemplary method for determining a power gain and a beam ID for each RS in Embodiment 2 of the present disclosure. Referring to FIG. 5, it is assumed that the set of RSs includes six RSs, e.g., denoted by RS #0, RS #1, RS #2, RS #3, RS #4, and RS #5; the configuration information indicates two power gains (e.g., denoted as P #0 and P #1) and three beam IDs (e.g., denoted as b #0, b #1, and b #2) for the six RSs, and the mapping order is mapping (or sweeping) the power gain firstly and beam secondly. Then, the network node may determine that P #0 and b #0 for RS #0, P #1 and b #0 for RS #1, P #0 and b #1 for RS #2, P #1 and b #1 for RS #3, P #0 and b #2 for RS #4, and P #1 and b #2 for RS #5.

### Embodiment III

In embodiment III, the set of RSs may be used for a beam measurement for the network node.

According to some embodiments of the present application, the set of RSs may be a set of DL RSs. All the definitions regarding the set of DL RSs in Embodiment I may apply here.

In embodiment III, each DL RS (or each DL resource) may be associated with a beam ID (or a TCI state ID or a QCL type D property) for DL forwarding. Accordingly, only the beam IDs (or TCI state IDs or QCL type D properties) may be swept for the set of DL RSs.

In embodiment II, the network node may determine a beam ID (or a TCI state ID or a QCL type D property) for each DL RS in the set of DL RSs in step 303. The beam ID (or a TCI state ID or a QCL type D property) may be determined based on the methods in the following embodiments.

In some embodiments, the beam ID (or the TCI state ID or the QCL type D property) for each DL RS are explicitly configured from the BS to the network node. In such embodiments, the configuration information may indicate a beam ID (or a TCI state ID or a QCL type D property) for each DL RS in the set of DL RSs. The network node may determine the beam ID (or the TCI state ID or the QCL type D property) for each DL RS in the set of DL RSs based on the indication.

In such embodiments, the network node may receive the set of DL RSs from the BS. Then, in step 305, the network node may transmit each DL RS in the set of DL RSs to a UE (e.g., UE 103 in FIG. 1 or UE 205a, 205b, or UE 205c in FIG. 2) based on the beam ID (or the TCI state ID or the QCL type D property) for each DL RS in the set of DL RSs. For the UE, the set of DL RSs may have the same purposes as legacy to keep transparent, e.g., the set of DL RSs may be used for at least one of: RSRP measurement, RSRQ measurement, or RSSI measurement.

In some cases, based on the measurements and reporting on the set of DL RSs from the UE, the BS may determine at least one beam ID (or TCI state ID or QCL type D property) which is suitable for the network node. Then, the BS may transmit an indication indicating the at least one beam ID (or TCI state ID or QCL type D property) to the network node. Consequently, the network node may receive the indication indicating the at least one beam ID (or TCI state ID or QCL type D property) from the BS.

In some other embodiments, the beam ID (or the TCI state ID or the QCL type D property) for each DL RS is determined by the network node. In such embodiments, the network node may receive the set of DL RSs from the BS. Then, in step 305, the network node may transmit each DL RS in the set of DL RSs to a UE (e.g., UE 103 in FIG. 1 or UE 205a, 205b, or UE 205c in FIG. 2) based on the determined beam ID (or TCI state ID or QCL type D property) for each DL RS in the set of DL RSs.

In some cases, based on the measurements and reporting on the set of DL RSs from the UE, the BS may determine index(es) of at least one DL RS (or at least one DL resource for the at least one DL RS) which is suitable for the network node. An index of a DL RS is associated with a determined or selected beam ID (or TCI state ID or QCL type D property) at the network node. The association between an index of a DL RS and a beam ID (or TCI state ID or QCL type D property) may be determined by the network node's implementation. Then, the BS may transmit an indication to the network node, the indication may include an index of each DL RS of the at least one DL RS (or an index of each DL resource of the at least one DL resource). Consequently, the network node may receive the indication. Based the index of each DL RS (or the index of each DL resource), the network node may determine a corresponding beam ID (or TCI state ID or QCL type D property) associated with the index for each DL RS (or the index of each DL resource).

According to some embodiments of the present application, the set of RSs may be a set of UL RSs. All the definitions regarding the set of UL RSs in Embodiment I may apply here.

In embodiment III, each UL RS (or each UL resource) may be associated with a beam ID (or a TCI state ID or a QCL type D property) for UL forwarding. Accordingly, only the beam IDs (or TCI state IDs or QCL type D properties) may be swept for the set of UL RSs.

In embodiment III, the network node may determine a beam ID (or a TCI state ID or a QCL type D property) for each UL RS in the set of UL RSs in step 303. The beam ID (or TCI state ID or QCL type D property) may be determined based on the methods in the following embodiments.

In some embodiments, the beam ID (or the TCI state ID or the QCL type D property) for each UL RS are explicitly configured from the BS to the network node. In such embodiments, the configuration information may indicate a beam ID (or a TCI state ID or a QCL type D property) for each UL RS in the set of UL RSs. The network node may determine the beam ID (or the TCI state ID or the QCL type D property) for each UL RS in the set of UL RSs based on the indication.

In such embodiments, the network node may receive the set of UL RSs from the UE. Then, in step 305, the network node may transmit each UL RS in the set of UL RSs to the BS based on the determined beam ID (or the TCI state ID or the QCL type D property) for each UL RS in the set of UL RSs. For the UE, the set of UL RSs may have the same purposes as legacy to keep transparent.

In some cases, based on the measurements on the set of UL RSs, the BS may determine at least one beam ID (or TCI state ID or QCL type D property) which is suitable for the network node. Then, the BS may transmit an indication indicating the at least one beam ID (or TCI state ID or QCL type D property) to the network node. Consequently, the network node may receive the indication indicating the at least one beam ID (or TCI state ID or QCL type D property) from the BS.

In some other embodiments, the beam ID (or the TCI state ID or the QCL type D property) for each UL RS is determined by the network node. In such embodiments, the network node may receive the set of UL RSs from the UE. Then, in step 305, the network node may transmit each UL RS in the set of UL RSs to the BS based on the determined beam ID (or TCI state ID or QCL type D property) for each UL RS in the set of UL RSs.

In some cases, based on the measurements on the set of UL RSs, the BS may determine index(es) of at least one UL RS (or at least one UL resource for the at least one UL RS) which is suitable for the network node. An index of a UL RS is associated with a determined or selected beam ID (or TCI state ID or QCL type D property) at the network node. The association between an index of a UL RS and a beam ID (or TCI state ID or QCL type D property) may be determined by the network node's implementation. Then, the BS may transmit an indication to the network node, the indication may include an index of each UL RS of the at least one UL RS (or an index of each UL resource of the at least one UL resource). Consequently, the network node may receive the indication. Based the index of each UL RS (or the index of each UL resource), the network node may determine a corresponding beam ID (or TCI state ID or QCL type D property) associated with the index for each UL RS (or the index of each UL resource).

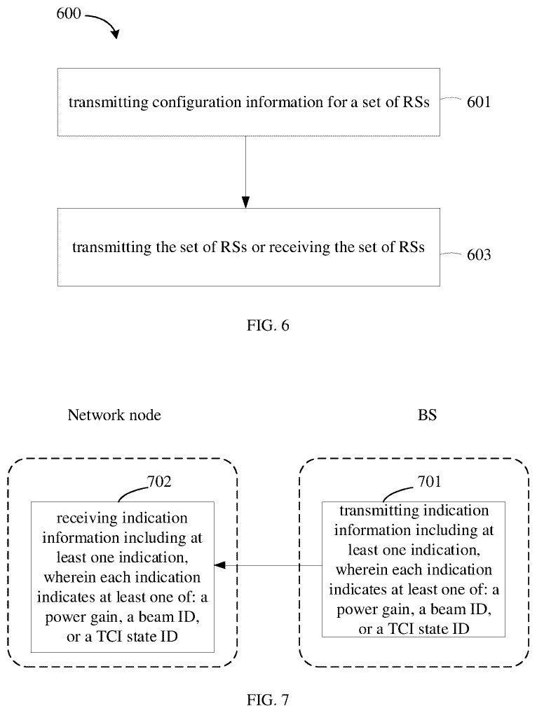

FIG. 6 is a flow chart illustrating an exemplary method 600 for determining at least one of a power gain or a beam for a repeater according to some other embodiments of the present disclosure. The method in FIG. 6 may be implemented by a BS (e.g., BS 101 in FIG. 1 or BS 201 in FIG. 2) or other network node with the similar functions.

In the exemplary method shown in FIG. 6, in step 601, the BS may transmit, to a network node, e.g., a repeater (e.g., repeater 203a or 203b in FIG. 2) or other network node with the like functions, configuration information for a set of RSs. In step 603, the BS may transmit or receive the set of RSs from the network node. The specific operations in each step may be illustrated in the following embodiments.

### Embodiment I′

In embodiment I, the set of RSs may be used for a power gain measurement for the network node.

According to some embodiments of the present application, the set of RSs may be a set of DL RSs. All the definitions regarding the set of DL RSs in Embodiment I may apply here.

In some embodiments, the power gain for each DL RS is explicitly configured from the BS to the network node. In such embodiments, the BS may determine a power gain for each DL RS in the set of DL RSs, and indicate the power gain for each DL RS in the set of DL RSs in the configuration information.

In such embodiments, the BS may transmit the set of DL RSs to the network node in step 603. Then, the network node may transmit the set of DL RSs to a UE (e.g., UE 103 in FIG. 1 or UE 205a, 205b, or UE 205c in FIG. 2) based on the power gain for each DL RS in the set of DL RSs indicated by the BS.

In some cases, based on the measurements and reporting on the set of DL RSs from the UE, the BS may determine at least one power gain which is suitable for the network node. Then, the BS may transmit an indication indicating the at least one power gain to the network node.

In some other embodiments, the power gain for each DL RS is determined by the network node itself. In such embodiments, the BS may transmit the set of DL RSs to the network node in step 603. Then, the network node may transmit each DL RS in the set of DL RSs to a UE (e.g., UE 103 in FIG. 1 or UE 205a, 205b, or UE 205c in FIG. 2) based on the power gain for each DL RS in the set of DL RSs determined by itself.

In some cases, based on the measurements and reporting on the set of DL RSs from the UE, the BS may determine index(es) of at least one DL RS (or at least one DL resource for the at least one DL RS) which is suitable for the network node. An index of a DL RS is associated with a determined or selected power gain at the network node. The association between an index of a DL RS and a power gain may be determined by the network node's implementation. Then, the BS may transmit an indication to the network node, the indication may include an index of each DL RS of the at least one DL RS (or an index of each DL resource of the at least one DL resource). Consequently, the network node may receive the indication.

According to some embodiments of the present application, the set of RSs may be a set of UL RSs. All the definitions regarding the set of UL RSs in Embodiment I may apply here.

In some embodiments, the power gain for each UL RS is explicitly configured from the BS to the network node. In such embodiments, the BS may determine a power gain for each UL RS in the set of UL RSs, and indicate the power gain for each UL RS in the set of UL RSs in the configuration information.

In such embodiments, the BS may receive the set of UL RSs from the network node in step 603. In some cases, based on the measurements on the set of UL RSs, the BS may determine at least one power gain which is suitable for the network node. Then, the BS may transmit an indication indicating the at least one power gain to the network node.

In some other embodiments, the power gain for each UL RS is determined by the network node itself. There will be an association between an index of a UL RS and a determined power gain. In such embodiments, the BS may receive the set of UL RSs from the network node in step 603. In some cases, based on the measurements on the set of UL RSs, the BS may determine index(es) of at least one UL RS (or at least one UL resource for the at least one UL RS) which is suitable for the network node. An index of a UL RS is associated with a determined or selected power gain at the network node. The association between an index of a UL RS and a power gain may be determined by the network node's implementation. Then, the BS may transmit an indication to the network node, the indication may include an index of each UL RS of the at least one UL RS (or an index of each UL resource of the at least one UL resource).

### Embodiment II′

In embodiment II, the set of RSs may be used for a power gain measurement and a beam measurement for the network node.

According to some embodiments of the present application, the set of RSs may be a set of DL RSs. All the definitions regarding the set of DL RSs in Embodiment II may apply here.

In some embodiments, the power gain and the beam ID (or the TCI state ID or the QCL type D property) for each DL RS are explicitly configured from the BS to the network node. In such embodiments, the BS may determine a power gain and a beam ID (or a TCI state ID or a QCL type D property) for each DL RS, and indicate the power gain and the beam ID (or the TCI state ID or the QCL type D property) for each DL RS in the configuration information.

In such embodiments, the BS may transmit the set of DL RSs to the network node in step 603. Then, the network node may transmit each DL RS in the set of DL RSs to a UE (e.g., UE 103 in FIG. 1 or UE 205a, 205b, or UE 205c in FIG. 2) based on the power gain and the beam ID (or the TCI state ID or the QCL type D property) for each DL RS in the set of DL RSs indicated by the BS.

In some cases, based on the measurements and reporting on the set of DL RSs from the UE, the BS may determine at least one set of power gain and beam ID (or TCI state ID or QCL type D property) which is suitable for the network node. Then, the BS may transmit an indication indicating the at least one set of power gain and beam ID (or TCI state ID or QCL type D property) to the network node.

In some other embodiments, the power gain and the beam ID (or the TCI state ID or the QCL type D property) for each DL RS is determined by the network node.

In an embodiment, the configuration information in step 301 may further indicates a first number of beam IDs (or TCI state IDs or QCL type D properties) and a second number of power gains associated with the set of DL RSs. In some cases, the configuration information also indicates a mapping order between the set of DL RSs and the first number of beam IDs (or TCI state IDs or QCL type D properties) and the second number of power gains.

In such embodiments, the BS may transmit the set of DL RSs to the network node in step 603. Then, the network node may transmit each DL RS in the set of DL RSs to a UE (e.g., UE 103 in FIG. 1 or UE 205a, 205b, or UE 205c in FIG. 2) based on the power gain and beam ID (or TCI state ID or QCL type D property) for each DL RS in the set of DL RSs determined by itself.

In some cases, based on the measurements and reporting on the set of DL RSs from the UE, the BS may determine index(es) of at least one DL RS (or at least one DL resource for the at least one DL RS) which is suitable for the network node. An index of a DL RS is associated with a determined or selected power gain and a determined or selected beam ID (or TCI state ID or QCL type D property) at the network node. The association between an index of a DL RS and a power gain and a beam ID (or TCI state ID or QCL type D property) may be determined by the network node's implementation. Then, the BS may transmit an indication to the network node, the indication may include an index of each DL RS of the at least one DL RS (or an index of each DL resource of the at least one DL resource).

According to some embodiments of the present application, the set of RSs may be a set of UL RSs. All the definitions regarding the set of UL RSs in Embodiment II may apply here.

In some embodiments, the power gain and the beam ID (or the TCI state ID or the QCL type D property) for each UL RS are explicitly configured from the BS to the network node. In such embodiments, the BS may determine a power gain and a beam ID (or a TCI state ID or a QCL type D property) for each UL RS, and indicate the power gain and the beam ID (or the TCI state ID or the QCL type D property) for each UL RS in the configuration information

In such embodiments, the BS may receive the set of UL RSs from the UE. In some cases, based on the measurements on the set of UL RSs, the BS may determine at least one set of power gain and beam ID (or TCI state ID or QCL type D property) which is suitable for the network node. Then, the BS may transmit an indication indicating the at least one set of power gain and beam ID (or TCI state ID or QCL type D property) to the network node.

In some other embodiments, the power gain and the beam ID (or the TCI state ID or the QCL type D property) for each UL RS is determined by the network node.

In an embodiment, the configuration information in step 301 may further indicates a first number of beam IDs (or TCI state IDs or QCL type D properties) and a second number of power gains associated with the set of UL RSs. In some cases, the configuration information also indicates a mapping order between the set of UL RSs and the first number of beam IDs (or TCI state IDs or QCL type D properties) and the second number of power gains.

In such embodiments, the BS may receive the set of UL RSs from the network node. In some cases, based on the measurements on the set of UL RSs, the BS may determine index(es) of at least one UL RS (or at least one UL resource for the at least one UL RS) which is suitable for the network node. An index of a UL RS is associated with a determined or selected power gain and a determined or selected beam ID (or TCI state ID or QCL type D property) at the network node. The association between an index of a UL RS and a power gain and a beam ID (or TCI state ID or QCL type D property) may be determined by the network node's implementation. Then, the BS may transmit an indication to the network node, the indication may include an index of each UL RS of the at least one UL RS (or an index of each UL resource of the at least one UL resource).

### Embodiment III′

In embodiment III, the set of RSs may be used for a beam measurement for the network node.

According to some embodiments of the present application, the set of RSs may be a set of DL RSs. All the definitions regarding the set of DL RSs in Embodiment III′ may apply here.

In some embodiments, the beam ID (or the TCI state ID or the QCL type D property) for each DL RS are explicitly configured from the BS to the network node. In such embodiments, the BS may determine a beam ID (or a TCI state ID or a QCL type D property) for each DL RS, and indicate the beam ID (or the TCI state ID or the QCL type D property) for each DL RS in the configuration information.

In such embodiments, the BS may transmit the set of DL RSs to the network node in step 603. Then, the network node may transmit each DL RS in the set of DL RSs to a UE (e.g., UE 103 in FIG. 1 or UE 205a, 205b, or UE 205c in FIG. 2) based on the beam ID (or the TCI state ID or the QCL type D property) for each DL RS in the set of DL RSs indicated by the BS.

In some cases, based on the measurements and reporting on the set of DL RSs from the UE, the BS may determine at least one beam ID (or TCI state ID or QCL type D property) which is suitable for the network node. Then, the BS may transmit an indication indicating the at least one beam ID (or TCI state ID or QCL type D property) to the network node.

In some other embodiments, the beam ID (or the TCI state ID or the QCL type D property) for each DL RS is determined by the network node. In such embodiments, the BS may transmit the set of DL RSs to the network node in step 603. Then, the network node may transmit each DL RS in the set of DL RSs to a UE (e.g., UE 103 in FIG. 1 or UE 205a, 205b, or UE 205c in FIG. 2) based on the beam ID (or TCI state ID or QCL type D property) for each DL RS in the set of DL RSs determined by itself.

In some cases, based on the measurements and reporting on the set of DL RSs from the UE, the BS may determine index(es) of at least one DL RS (or at least one DL resource for the at least one DL RS) which is suitable for the network node. An index of a DL RS is associated with a determined or selected beam ID (or TCI state ID or QCL type D property) at the network node. The association between an index of a DL RS and a beam ID (or TCI state ID or QCL type D property) may be determined by the network node's implementation. Then, the BS may transmit an indication to the network node, the indication may include an index of each DL RS of the at least one DL RS (or an index of each DL resource of the at least one DL resource).

According to some embodiments of the present application, the set of RSs may be a set of UL RSs. All the definitions regarding the set of UL RSs in Embodiment I may apply here.

In some embodiments, the beam ID (or the TCI state ID the QCL type D property) for each UL RS are explicitly configured from the BS to the network node. In such embodiments, the BS may determine a beam ID (or a TCI state ID or a QCL type D property) for each UL RS in the set of UL RSs, and indicate the beam ID (or the TCI state ID or the QCL type D property) for each UL RS in the configuration information.

In such embodiments, the BS may receive the set of UL RSs from the network node. In some cases, based on the measurements on the set of UL RSs, the BS may determine at least one beam ID (or TCI state ID or QCL type D property) which is suitable for the network node. Then, the BS may transmit an indication indicating the at least one beam ID (or TCI state ID or QCL type D property) to the network node.

In some other embodiments, the beam ID (or the TCI state ID or the QCL type D property) for each UL RS is determined by the network node. In such embodiments, the BS may receive the set of UL RSs from the network node.

In some cases, based on the measurements on the set of UL RSs, the BS may determine index(es) of at least one UL RS (or at least one UL resource for the at least one UL RS) which is suitable for the network node. An index of a UL RS is associated with a determined or selected beam ID (or TCI state ID or QCL type D property) at the network node. The association between an index of a UL RS and a beam ID (or TCI state ID or QCL type D property) may be determined by the network node's implementation. Then, the BS may transmit an indication to the network node, the indication may include an index of each UL RS of the at least one UL RS (or an index of each UL resource of the at least one UL resource).

According to some embodiments of the present application, at least one of a power gain or a beam ID (or a TCI state ID or a QCL type D property) may be indicated by a BS to the network node. FIG. 7 is a flow chart illustrating an exemplary method 700 for indicating at least one of a power gain and a beam for a repeater according to some embodiments of the present disclosure. Although the method in FIG. 7 is illustrated in a system level by a BS (e.g., BS 101 in FIG. 1 or BS 201 in FIG. 2) and a network node, e.g., a repeater (e.g., repeater 203a or 203b in FIG. 2), persons skilled in the art should understand that the method implemented in the BS and the network node can be separately implemented and/or incorporated by other apparatus with the similar functions. In some embodiments of FIG. 7, the repeater may be an NC repeater or a smart repeater. In some other embodiments, the repeater may be any other repeater.

The method in FIG. 7 may be performed separately or may be performed based on the method in FIGS. 3 and 6, for example, the method in FIG. 7 may be performed following the steps in FIGS. 3 and 6, e.g., based on the measurements for the set of DL RSs or UL RSs, as illustrated in FIGS. 3 and 6.

Referring to FIG. 7, in step 701, the BS may transmit indication information to a network node. The indication information may include at least one indication, wherein each indication may indicate at least one of a power gain or a beam ID (or a TCI state ID or a QCL type D property). Consequently, in step 702, the network node may receive the indication information from the BS.

In some embodiments, each indication may directly indicate at least one of a power gain or a beam ID (or a TCI state ID or a QCL type D property). For example, the indication may include at least one of a power gain value or a beam ID (or a TCI state ID or a QCL type D property).

In some other embodiments, each indication may indicate an index of an RS (or an index of a resource for transmitting the RS). The index of the RS (or an index of a resource for transmitting the RS) may be associated with at least one of a power gain or a beam ID (or a TCI state ID or a QCL type D property), which is illustrated in the embodiments of FIG. 3 and FIG. 6. In such embodiments, the RS may be a DL RS or a UL RS.

In some embodiments of the present application, the indication information may be periodic indication information. In such embodiments, the BS may transmit, to the network node, at least one of the following information for the periodic indication information:
a periodicity of the indication information;
a duration, which may define a time period in which the indication information is used;
an offset, which may be used to define the starting position of the duration within a periodicity, for example, a period between slot #0 and the starting position of the duration may be defined as the offset; or
time instance index(es), which may define index(es) of time instance(s) to use the indication information. A time instance in the embodiments of the present application may be in units of slots, sub-slots, symbols, etc. For example, a time instance may be a slot. In some embodiments, a time instance may also be referred to as a time domain resource.

The network node or the BS may determine at least one of a power gain or a beam ID (or a TCI state ID or a QCL type D property) for each time instance in the duration based on the above information.

FIG. 8 is an exemplary method for determining power gains for a duration according to some embodiments of the present disclosure.

Referring to FIG. 8, it is assumed that the indication information includes 6 indications, each indication indicates a power gain for a corresponding time instance (e.g., denoted as T). For example, the six power gains indicated by the indication information may be defined as P #0, P #1, P #0, P #2, P #3, and P #4.

Moreover, it is also assumed that the BS transmit a periodicity (not shown in FIG. 8), an offset (not shown in FIG. 8), a duration and time instance indexes for the indication information. For example, the duration may include 6 time instances, and the time instance indexes are #0, #2, #4, #6, #8, and #10. Based on the aforementioned information, the network node or the BS may determine P #0 for T #0, P #1 for T #2, P #0 for T #4, P #2 for T #6, P #3 for T #8, and P #4 for T #10. For other time instances within the duration, as there is no indication indicating a power grain for them, the network node or the BS may determine a default power gain (e.g., denoted as P_d) for these time instances.

In some embodiments of the present application, the indication information may be aperiodic indication information. In such embodiments, the BS may transmit, to the network node, at least one of the following information for the aperiodic indication information:
an application time; the network node or the BS may apply the indication information after the application time; The application time may be one or multiple slot, sub-slot, symbol, etc.; or
a duration, which may define a time period in which the indication information is used. The duration may be in units of slots, sub-slots, symbols, etc.

In an embodiment, an aperiodic indication has a higher priority than a periodic indication. A later indication has a higher priority than an earlier indication.

In an embodiment, when no power gain is indicated for a time instance (e.g., no periodic indication and aperiodic indication is available for a time instance), the BS or the network node may determine a default power gain for the time instance.

In some embodiments of the present application, each indication may indicate a power gain, and thus the at least one indication may indicate at least one power gain. In some cases, the at least one power gain may be indicated per beam.

For example, the BS may transmit, to the network node, a mapping relationship between at least one power gain indicated by the indication information and at least one beam ID (or at least one TCI state ID), wherein each power gain may be associated with the a corresponding beam ID (or TCI state ID or QCL type D property). In such example, once a beam ID (or a TCI state ID or a QCL type D property) is determined for a time instance, the BS or the network node may determine a power gain for the time instance based on the beam ID or the TCI state ID associated with the power gain.

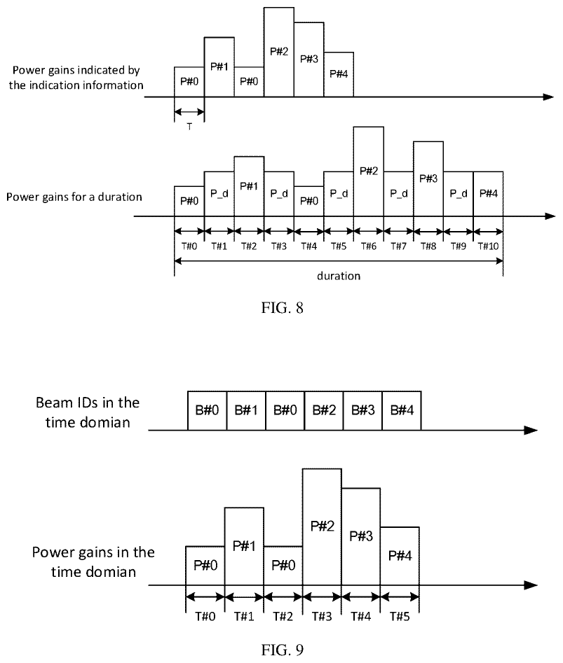

FIG. 9 is an exemplary method for determining power gains for a duration according to some other embodiments of the present disclosure.

Referring to FIG. 9, it is assumed that the indication information indicates 5 power gains (e.g., denoted as P #0-P #4), which are not shown in FIG. 9. In addition, it is also assumed that the mapping relationship indicates that P #0-P #4 are associated with beam IDs B #0-B #4, respectively. It is assumed that the network node or the BS determines B #0, B #1, B #0, B #2, B #3, and B #4 for time instances T #0-T #5, respectively, then the network mode or the BS may determine that the power gain for T #0-T #5 are P #0, P #1, P #0, P #2, P #3, and P #4, respectively.

In another embodiment, the at least one power gain indicated by the indication information may be associated with one or more beam IDs (or one or more TCI state IDs or one or more QCL type D properties), and each beam ID (or each TCI state ID or each QCL type D property) may be associated with one or more power gains of the at least one power gain, wherein each gain may be used for a corresponding time instance for the beam. In such embodiments, the network node or the BS may determine a power gain for a time instance based on a beam ID (or a TCI state ID or a QCL type D property) for the time instance.

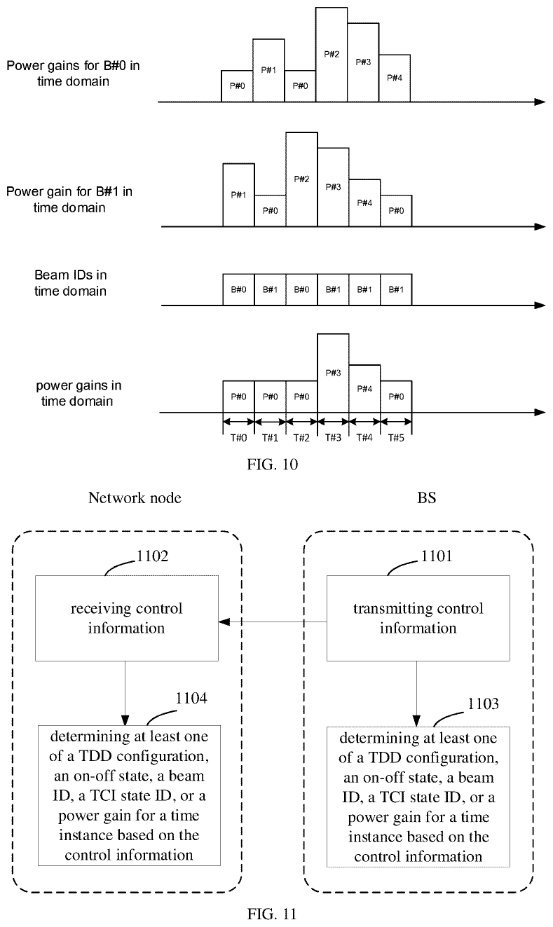

FIG. 10 is an exemplary method for determining power gains for a duration according to some other embodiments of the present disclosure.

Referring to FIG. 10, it is assumed that the indication information indicates 6 power gains (e.g., denoted as P #0, P #1, P #0, P #2, P #3, and P #4) for a beam ID (e.g., denoted as B #0) in a duration includes 6 time instances (e.g., denoted as T #0-T #5), and also indicates 6 power gains (e.g., denoted as P #1, P #0, P #2, P #3, P #4, and P #0) for another beam ID (e.g., denoted as B #1) in the duration, wherein each power gain may be associated with a corresponding time instance.

In addition, it is also assumed that the network node or the BS determines B #0, B #1, B #0, B #1, B #1, and B #1 for T #0-T #5, respectively, then the network mode or the BS may determine that the power gains for T #0-T #5 are P #0, P #0, P #0, P #3, P #4, and P #0, respectively.

In some embodiments of the present application, the at least one indication may be separately for DL and UL or jointly for DL and UL.

In some embodiments of the present application, the indication information may be transmitted by the BS (or received by the network node) in group common DCI or in a MAC CE.

As stated above, in some cases, there may be multiple kinds of side control information configured for a network node. The following embodiments provide solutions regarding how to determine the side control information for a time instance.

FIG. 11 is a flow chart illustrating an exemplary method for determining control information according to some embodiments of the present disclosure. Although the method in FIG. 11 is illustrated in a system level by a BS (e.g., BS 101 in FIG. 1 or BS 201 in FIG. 2) and a network node, e.g., a repeater (e.g., repeater 203a or 203b in FIG. 2), persons skilled in the art should understand that the method implemented in the BS and the network node can be separately implemented and/or incorporated by other apparatus with the like functions. In some embodiments of FIG. 11, the repeater may be an NC repeater or a smart repeater. In some other embodiments, the repeater may be any other repeater.

Referring to FIG. 11, in step 1101, a BS may transmit control information (e.g., side control information) to a network node. The control information may include at least one of:
an on-off configuration which indicates an on-off state for each time instance of at least one time instance. The on-off configuration may be at least one of: a semi-static on-off configuration or a dynamic on-off configuration. An on-off state for a time instance may indicate an on state for the time instance or an off state for the time instance;
a TDD configuration which indicates DL, UL or flexible for each time instance of at least one time instance. The TDD configuration may be at least one of: a semi-static TDD configuration or a dynamic TDD configuration;
one or more beam related indications (or one or more TCI state related indications or one or more QCL type D property related indications), wherein each beam related indication (or each TCI state related indication or each QCL type D property related indication) indicates a beam ID (or a TCI state ID or a QCL type D property) for a corresponding time instance of at least one time instance; or
one or more power gain indications, wherein each power gain indication indicates a power gain for a corresponding time instance of at least one time instance.

A time instance in the embodiments of the present application may be in units of slots, sub-slots, symbols, etc. For example, a time instance may be a slot. In some embodiments, a time instance may also be referred to as a time domain resource.

Consequently, in step 1102, the network node may receive the control information from the BS.

In some embodiments, each kind of the above control information may be associated with a corresponding priority. In an embodiment, the priority may be explicitly configured by the BS to the network node or implicitly determined by the type of the control information. For example, an on-off configuration may have a higher priority than other control information.

In some embodiments, a beam related indication (or a TCI state related indication or a QCL type D property related indication) may correspond to at least one of: a corresponding cell specific RS (or channel), a UE specific dynamic scheduling, a grant free scheduling (e.g., semi-persistent scheduling (SPS), etc. A beam related indication (or a TCI state related indication or a QCL type D property related indication) may be associated with a priority. The following embodiments may provide methods for determining a priority for a beam related indication (or a TCI state related indication or a QCL type D property related indication).

In an embodiment, the one or more beam related indications (or one or more TCI state related indications or one or more QCL type D property related indications) may include at least one beam related indication (or TCI state related indication or QCL type D property related indication) transmitted in a periodic way and at least one beam related indication (or TCI state related indication or QCL type D property related indication) transmitted in an aperiodic way. In such embodiment, the priority for each beam related indication (or TCI state related indication or QCL type D property related indication) may be explicitly configured by the BS to the network node or implicitly determined by the BS or the network node such that an aperiodic beam related indication (or TCI state related indication or QCL type D property related indication) has a higher priority than a periodic beam related indication (or TCI state related indication or QCL type D property related indication). In such embodiment, when a periodic beam related indication (or TCI state related indication or QCL type D property related indication) and an aperiodic beam related indication (or TCI state related indication or QCL type D property related indication) are indicated or determined for a same time instance, the actual beam related indication (or TCI state related indication or QCL type D property related indication) may be a beam related indication (or TCI state related indication or QCL type D property related indication) having the highest priority.

In an embodiment, a priority of a beam related indication (or TCI state related indication or QCL type D property related indication) may be explicitly configured in the control information. For example, one or multiple bits may be added in the control information together with the one or more beam related indications (or one or more TCI state related indications or one or more QCL type D property related indications) to indicate the priority for each beam related indication (or TCI state related indication or QCL type D property related indication).

In an embodiment, a priority of a beam related indication (or TCI state related indication or QCL type D property related indication) may be implicitly determined by the network node or the BS. For example, the BS or the network node may determine a priority of a beam related indication (or TCI state related indication or QCL type D property related indication) based on at least one of: a scrambling ID of a physical downlink channel (e.g., PDCCH or PDSCH), a an RNTI of a physical downlink channel (e.g., PDCCH or a PDSCH), whether the beam related indication (or the TCI state related indication or the QCL type D property related indication) is periodic or aperiodic, etc.

In some embodiments, a power gain indication may be associated with a priority. The following embodiments may provide methods for determining a priority for a power gain indication.

In an embodiment, the one or more power gain indications may include at least one power gain indication transmitted in a periodic way and at least one power gain indication transmitted in an aperiodic way. In such embodiment, the priority for each power gain indication may be explicitly configured by the BS to the network node or implicitly determined by the BS or the network node such that an aperiodic power gain indication has a higher priority than a periodic power gain indication. In such embodiments, when a periodic power gain indication and an aperiodic power gain indication are indicated or determined for a same time instance, the actual power gain indication may be a power gain indication having the highest priority.

In an embodiment, a priority of a power gain indication may be explicitly configured in the control information. For example, one or multiple bits may be added in the control information together with the one or more power gain indications to indicate the priority for each power gain indication.

In an embodiment, a priority of a power gain indication may be implicitly determined by the network node or the BS. For example, the BS or the network node may determine a priority of a power gain indication based on at least one of: a scrambling ID of a physical downlink channel (e.g., PDCCH or a PDSCH), an RNTI of a physical downlink channel (e.g., PDCCH or a PDSCH), whether the power gain indication is periodic or aperiodic, etc.

In step 1103, the BS may determine at least one of a TDD configuration, an on-off state, a beam ID (or a TCI state ID or a QCL type D property), or a power gain for a time instance based on the control information. In step 1104, the network node may determine at least one of a TDD configuration, an on-off state, a beam ID, a TCI state ID, or a power gain for a time instance based on the control information. The TDD configuration for a time instance may be DL, UL or flexible for the time instance. The BS and the network node may use the same methods to determine the above information for a time instance, which may be illustrated in the following embodiments.

In some embodiments of the present application, the on-off configuration may be included in the control information. Then, for a time instance:
In the case that at least one of the TDD configuration indicates flexible for the time instance or the on-off configuration indicates an off state for the time instance, the BS or the network node may determine the time instance to be an off state;
Otherwise, the time instance may be indicated as DL or UL based on the TDD configuration for the time instance;
In addition, regarding the beam ID (or a TCI state ID or a QCL type D property) for the time instance, it may be determined based on a beam related indication (or a TCI state related indication or a QCL type D property related indication) with a highest priority. For example, in the case that the control information includes more than one beam related indication (or more than one TCI state related indication or more than one QCL type D property related indication) for the time instance, the BS or the network node may determine a beam related indication (or a TCI state related indication or QCL type D property related indication) with a highest priority from the more than one beam related indication (or more than one TCI state related indication or more than one QCL type D property related indication) for the time instance;
Moreover, regarding the power gain for the time instance, it may be determined based on a power gain indication with a highest priority. For example, in the case that the control information includes more than one power gain indication for the time instance, the BS or the network node may determine a power gain indication with a highest priority from the more than one power gain indication for the time instance.
In some cases, if a power gain is determine based on a beam ID, then the power gain for a time instance is also determined based on the beam ID with highest priority for the time instance.

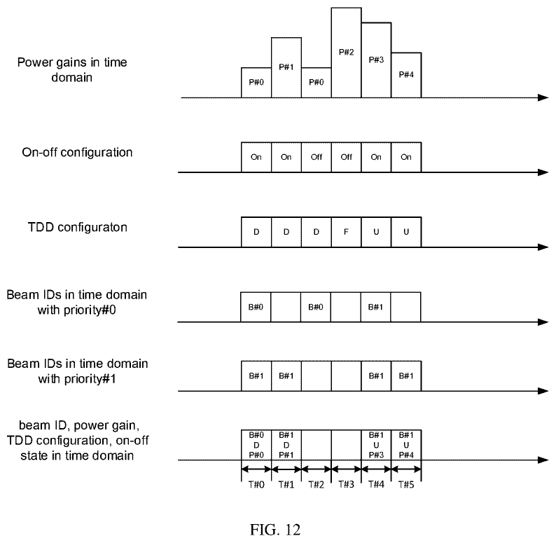

FIG. 12 is an exemplary method for determining control information according to some embodiments of the present disclosure. In the example of FIG. 12, the control information may include the on-off configuration.

Referring to FIG. 12, the control information in step 1101 may include the following information for a duration including six time instances, e.g., T #0-T #5:
an on-off configuration which indicates “ON,” “ON,” “OFF,” “OFF,” “ON,” “ON” states for T #0-T #5, respectively;
a TDD configuration which indicates “DL,” “DL,” “DL,” “flexible,” “UL,” and “UL” for T #0-T #5, respectively, wherein “DL” may be denoted as “D,” “flexible” may be denoted as “F,” and “UL” may be denoted as “U” in FIG. 12;
three beam related indications which are associated with priority #0 and indicate three beam IDs (e.g., denoted B #0, B #0, B #1) for T #0, T #2, and T #4, respectively;
four beam related indications which are associated with priority #1 and indicate four beam IDs (e.g., denoted B #1, B #1, B #1, and B #1) for T #0, T #1, T #4, and T #5, respectively; and
six power gain indications which indicate six power gains (e.g., denoted as P #0, P #1, P #0, P #2, P #3, and P #4) for T #0-T #5, respectively.

The BS or the network node may determine a TDD configuration, an on-off state, a beam ID, and a power gain for each time instance. For example, for T #2 and T #3, the BS or the network node may determine an off state for them because the on-off configuration indicating “OFF” and “OFF” for T #2 and T #3; for T #0, the BS or the network node may determine “DL” based on the TDD configuration, P #0 based on the power gain indication, and B #0 indicated by a beam related indication with a higher priority; for T #1, the BS or the network node may determine “DL” based on the TDD configuration, P #1 based on the power gain indication, and B #1 indicated by a beam related indication associated with T #1; for T #4, the BS or the network node may determine “UL” based on the TDD configuration, P #3 based on the power gain indication, and B #1 indicated by a beam related indication with a higher priority; for T #5, the BS or the network node may determine “UL” based on the TDD configuration, P #4 based on the power gain indication, and B #1 indicated by a beam related indication associated with T #5.

In some embodiments of the present application, the on-off configuration may be not included in the control information. Then, for a time instance:
in the case that at least one of the TDD configuration indicates flexible for the time instance, a beam related indication indicates a pre-defined beam ID for the time instance (or a TCI state related indication indicates a pre-defined TCI state ID for the time instance or a QCL type D property related indication indicates a pre-defined QCL type D property for the time instance), or a power gain indication indicates a pre-defined power gain for the time instance, the BS or the network node may determine the time instance to be an off state;
Otherwise, the operations in the above embodiments (i.e., the embodiments in which the on-off configuration is included in the control information) may apply here.

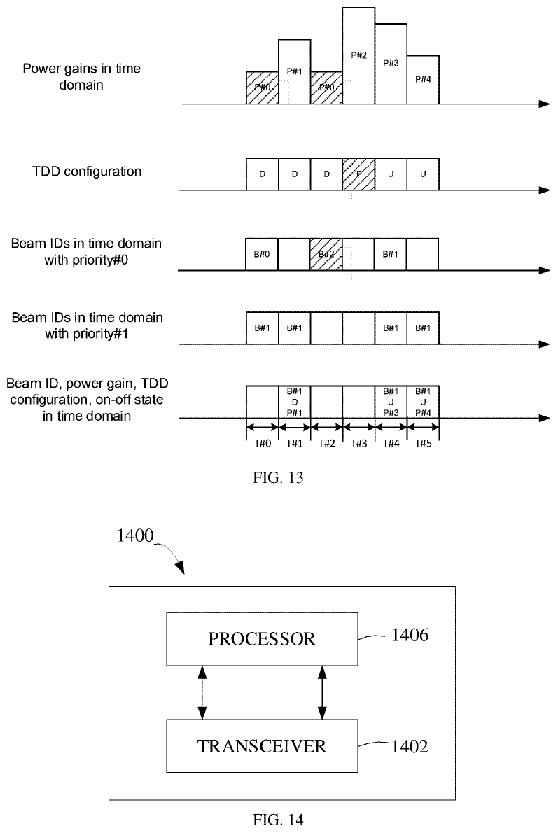

FIG. 13 is an exemplary method for determining control information according to some embodiments of the present disclosure. In the example of FIG. 13, the control information may not include the on-off configuration.

Referring to FIG. 13, the control information in step 1101 may include the following information for a duration including six time instances, e.g., T #0-T #5:
a TDD configuration which indicates “DL,” “DL,” “DL,” “flexible,” “UL,” and “UL” for T #0-T #5, respectively, wherein “DL” may be denoted as “D,” “flexible” may be denoted as “F,” and “UL” may be denoted as “U” in FIG. 12;
three beam related indications which are associated with priority #0 and indicate three beam IDs (e.g., denoted B #0, B #2, B #1) for T #0, T #2, and T #4, respectively, wherein B #2 is the pre-defined beam ID as stated above;
four beam related indications which are associated with priority #1 and indicate four beam IDs (e.g., denoted B #1, B #1, B #1, and B #1) for T #0, T #1, T #4, and T #5, respectively; and
six power gain indications which indicate six power gains (e.g., denoted as P #0, P #1, P #0, P #2, P #3, and P #4) for T #0-T #5, respectively wherein P #0 is the pre-defined power gain as stated above.

The BS or the network node may determine a TDD configuration, an on-off state, a beam ID, and a power gain for each time instance. For example, for T #0, the BS or the network node may determine an off state for it because the power gain indication indicates a pre-defined power gain P #0 for the time instance; for T #1, the BS or the network node may determine “DL” based on the TDD configuration, P #1 based on the power gain indication, and B #1 indicated by a beam related indication associated with T #1; for T #2, the BS or the network node may determine an off state for it because the power gain indication indicates a pre-defined power gain P #0 for the time instance and a beam related indication indicates a pre-defined beam ID B #2 for the time instance; for T #3, the BS or the network node may an off state for it because the TDD configuration indicates flexible for it; for T #4, the BS or the network node may determine “UL” based on the TDD configuration, P #3 based on the power gain indication, and B #1 indicated by a beam related indication with a higher priority; for T #5, the BS or the network node may determine “UL” based on the TDD configuration, P #4 based on the power gain indication, and B #1 indicated by a beam related indication associated with T #5.

FIG. 14 illustrates a simplified block diagram of an exemplary apparatus for repeater according to some embodiments of the present disclosure. As shown in FIG. 14, the apparatus 1400 may include at least one processor 1406 and at least one transceiver 1402 coupled to the processor 1406. The apparatus 1400 may be a network node (e.g., a repeater) or a BS.

Although in this figure, elements such as the at least one transceiver 1402 and processor 1406 are described in the singular, the plural is contemplated unless a limitation to the singular is explicitly stated. In some embodiments of the present disclosure, the transceiver 1402 may be divided into two devices, such as a receiving circuitry and a transmitting circuitry. In some embodiments of the present disclosure, the apparatus 1400 may further include an input device, a memory, and/or other components.

In some embodiments of the present disclosure, the apparatus 1400 may be a network node (e.g., a repeater). The transceiver 1402 and the processor 1406 may interact with each other so as to perform the operations with respect to the network node (e.g., a repeater) described in FIGS. 2-13. In some embodiments of the present disclosure, the apparatus 1400 may be a BS. The transceiver 1402 and the processor 1406 may interact with each other so as to perform the operations with respect to the BS described in FIGS. 1-13.

In some embodiments of the present disclosure, the apparatus 1400 may further include at least one non-transitory computer-readable medium.

For example, in some embodiments of the present disclosure, the non-transitory computer-readable medium may have stored thereon computer-executable instructions to cause the processor 1406 to implement the method with respect to the UE as described above. For example, the computer-executable instructions, when executed, cause the processor 1406 interacting with transceiver 1402 to perform the operations with respect to the UE described in FIGS. 1-13.

In some embodiments of the present disclosure, the non-transitory computer-readable medium may have stored thereon computer-executable instructions to cause the processor 1406 to implement the method with respect to the BS as described above. For example, the computer-executable instructions, when executed, cause the processor 1406 interacting with transceiver 1402 to perform the operations with respect to the BS described in FIGS. 1-13.

Those having ordinary skill in the art would understand that the operations or steps of a method described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. Additionally, in some aspects, the operations or steps of a method may reside as one or any combination or set of codes and/or instructions on a non-transitory computer-readable medium, which may be incorporated into a computer program product.

While this disclosure has been described with specific embodiments thereof, it is evident that many alternatives, modifications, and variations may be apparent to those skilled in the art. For example, various components of the embodiments may be interchanged, added, or substituted in other embodiments. Also, all of the elements of each figure are not necessary for the operation of the disclosed embodiments. For example, one of ordinary skill in the art of the disclosed embodiments would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, are defined as “including.” Expressions such as “A and/or B” or “at least one of A and B” may include any and all combinations of words enumerated along with the expression. For instance, the expression “A and/or B” or “at least one of A and B” may include A, B, or both A and B. The wording “the first,” “the second” or the like is only used to clearly illustrate the embodiments of the present disclosure, but is not used to limit the substance of the present disclosure.

What is claimed is:

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. A network node for wireless communication, comprising:
at least one memory; and
at least one processor coupled with the at least one memory and configured to cause the network node to:
receive control information comprising at least one of:
an on-off configuration which indicates an on-off state for each time instance of at least one time instance;
a time division duplexing (TDD) configuration which indicates downlink (DL), uplink (UL), or flexible for each time instance of the at least one time instance; or
one or more beam related indications, wherein each beam related indication indicates a beam identity (ID) for a corresponding time instance of the at least one time instance; and
determine, based at least in part on the control information, at least one of a TDD configuration, an on-off state, or a beam ID for a time instance of the at least one time instance.

17. The network node of claim 16, wherein in a case that the on-off configuration is not included in the control information, the at least one processor is configured to cause the network node to determine the time instance to be an off state in response to a beam related indication indicating a pre-defined beam ID for the time instance.

18. The network node of claim 16, wherein a beam related indication is associated with a priority.

19. The network node of claim 18, wherein the priority is configured in the control information.

20. The network node of claim 16, wherein the control information comprises more than one beam related indication.

21. The network node of claim 20, wherein the at least one processor is configured to cause the network node to determine, for the time instance, a beam related indication with a highest priority from the more than one beam related indication.

22. The network node of claim 16, wherein the control information further comprises at least one of:
one or more transmission configuration indicator (TCI) state related indications, wherein each TCI state related indication indicates a TCI state ID for a corresponding time instance of at least one time instance;
one or more quasi-colocation (QCL) type D property related indications, wherein each QCL type D property related indication indicates a QCL type D property for a corresponding time instance of at least one time instance; or
one or more power gain indications, wherein each power gain indication indicates a power gain for a corresponding time instance of at least one time instance.

23. The network node of claim 22, wherein in a case that the on-off configuration is not included in the control information, the at least one processor is configured to cause the network node to determine the time instance to be an off state in response to one or more of at least one of the TDD configuration indicates flexible for the time instance, a TCI state related indication indicates a pre-defined TCI state ID, a QCL type D property related indication indicates a pre-defined QCL type D property, or a power gain indication indicates a pre-defined power gain for the time instance.

24. The network node of claim 22, wherein a QCL type D property related indication is associated with a priority, and the priority is configured in the control information.

25. The network node of claim 24, wherein the priority is determined based on at least one of: a scrambling identity (ID) of a physical downlink channel, a radio network temporary identity (RNTI) of a physical downlink channel, or whether a beam related indication, a TCI state related indication, or a QCL type D property related indication is periodic or aperiodic.

26. The network node of claim 16, wherein in a case that the on-off configuration is included in the control information, the at least one processor is configured to cause the network node to determine the time instance to be an off state in response to at least one of the TDD configuration indicates flexible for the time instance or the on-off configuration indicates an off state for the time instance.

27. A method performed by a network node, the method comprising:
receiving control information comprising at least one of:
an on-off configuration which indicates an on-off state for each time instance of at least one time instance;
a time division duplexing (TDD) configuration which indicates downlink (DL), uplink (UL), or flexible for each time instance of the at least one time instance; or
one or more beam related indications, wherein each beam related indication indicates a beam identity (ID) for a corresponding time instance of the at least one time instance; and
determining, based at least in part on the control information, at least one of a TDD configuration, an on-off state, or a beam ID for a time instance of the at least one time instance.

28. The method of claim 27, wherein in a case that the on-off configuration is not included in the control information, the method further comprises determining the time instance to be an off state in response to a beam related indication indicating a pre-defined beam ID for the time instance.

29. The method of claim 27, wherein a beam related indication is associated with a priority.

30. The method of claim 29, wherein the priority is configured in the control information.

31. The method of claim 27, the control information comprises more than one beam related indication.

32. The method of claim 31, further comprising determining, for the time instance, a beam related indication with a highest priority from the more than one beam related indication.

33. A processor for wireless communication, comprising:
at least one controller coupled with at least one memory and configured to cause the processor to:
receive control information comprising at least one of:
an on-off configuration which indicates an on-off state for each time instance of at least one time instance;
a time division duplexing (TDD) configuration which indicates downlink (DL), uplink (UL), or flexible for each time instance of the at least one time instance; or
one or more beam related indications, wherein each beam related indication indicates a beam identity (ID) for a corresponding time instance of the at least one time instance; and
determine, based at least in part on the control information, at least one of a TDD configuration, an on-off state, or a beam ID for a time instance of the at least one time instance.

34. A network node for wireless communication, comprising:
at least one memory; and
at least one processor coupled with the at least one memory and configured to cause the network node to:
determine at least one of a power gain, a beam identity (ID), a transmission configuration indicator (TCI) state ID, or a quasi-colocation (QCL) type D property for each reference signal (RS) in a set of RSs; and
transmit the set of RSs based on the determined at least one of the power gain, the beam ID, the TCI state ID, or the QCL type D property for each RS in the set of RSs.

35. The network node of claim 34, wherein the at least one processor is configured to cause the network node to receive configuration information comprising at least one of the power gain, the beam ID, the TCI state ID, or the QCL type D property for each RS in the set of RSs.
